(19) United States
(12) Patent Application Publication
(10) Pub. No.: US 2009/0276113 A1
(43) Pub. Date: Nov. 5, 2009

(54) WHEEL-STATE ESTIMATION DEVICE AND VEHICLE CONTROL DEVICE

(75) Inventor: Hideki Sugimoto, Ann Arbor, MI (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Toyota-shi (JP)

(21) Appl. No.: 12/067,870

(22) PCT Filed: Nov. 22, 2006
(86) PCT No.: PCT/JP2006/323873

§ 371 Date: Mar. 24, 2008

(30) Foreign Application Priority Data
Nov. 29, 2005 (JP) 2005-344722

(51) Int. Cl. B60T 8/172

(52) U.S. Cl. 701/29; 701/71

(57) ABSTRACT

In a wheel-state estimation device which estimates a force or acceleration acting on a wheel provided in an automotive vehicle, a plurality of wheel side detection units are respectively provided in a plurality of wheels of the vehicle, each wheel side detecting unit detecting a force or acceleration acting on a corresponding one of the wheels. An estimation unit estimates, when use of detection results of one of the wheels from one of the plurality of wheel side detection units is suspended, a force or acceleration acting on the one of the wheels with respect to the suspended use of the detection results, by using detection results of other wheels from other wheel side detection units.

### TECHNICAL FIELD

The present invention generally relates to a wheel-state estimation device and a vehicle control device, and more particularly to a wheel-state estimation device and a vehicle control device which are adapted for use in an automotive vehicle in which sensors that detect a force or acceleration acting on a wheel are provided in the wheel.

### BACKGROUND ART

Conventionally, there is known a tire for automotive vehicle in which a strain gage that detects a distortion of a rubber of a corresponding location is embedded in any location of a tread part, a sidewall part and a bead part of the tire. For example, see Japanese Laid-Open Patent Application No. 2003-226120. By using the tire of this kind, it is possible to monitor the contact situations of the tire and the road surface based on the output value of the strain gage.

Moreover, there is known a device which estimates a running state of an automotive vehicle based on the output level of vibration (vibration level) of a vehicle spring bottom part detected by a vibration sensor provided in the vehicle spring bottom part. For example, see International Publication No. WO 01/098123. In this device, the frequency spectrum of a vibration level is determined by performing frequency conversion of the vibration level of the vehicle spring bottom part detected by the vibration sensor, the vibration levels of at least two frequency bands of the obtained frequency spectrum are calculated, and a road surface condition is estimated by comparing the calculated vibration levels with the pre-recorded frequency spectrum master curve of the vibration levels.

Furthermore, there is known a tire grounding force detection method which detects the grounding force of a tire by using a detection signal the current value of which changes with a change of resistance of a pressure-sensitive electric conduction rubber which deforms when a wheel surface of a tread part of the tire grounds on a road surface. For example, see Japanese Laid-Open Patent Application No. 2005-082010.

Moreover, there is known a tire lateral/vertical force estimation method which estimates a lateral force or a vertical force acting on a tire by detecting and comparing the index of the tire grounding length having one-to-one correspondence with the tire grounding length, such as a grounding time of the tire tread part, at the plurality of positions of the tire. For example, see Japanese Laid-Open Patent Application No. 2005-205956.

Furthermore, there is known a tire force detection method which detects a fore-and-aft force, lateral force, or vertical force acting on a tire by detecting a tire surface distortion using a distortion sensor disposed on a sidewall part of the tire. For example, see Japanese Laid-Open Patent Application No. 2005-126008.

Moreover, there is known a tire sidewall torsion sensor which is associated with an encoder and supplies the output signal of a measured value pickup etc. to an automobile control system. For example, see Japanese Laid-Open Patent Application No. 2003-509666.

However, there is a case in which a malfunction of the communication path for transmitting the detection results of a sensor arises due to a certain cause. Especially when the sensor is provided in a wheel of the vehicle, the sensor or its communication path is placed under severe conditions because the sensor is subjected to external force, such as an impact or a rotating force acting on the wheel. There is also a case in which it is desirable to suspend the use of detection results of sensors from a viewpoint of the sensor reliability.

For these reasons, in order to perform appropriately vehicle control or notification of messages to the driver by using the detection results of sensors, it is desirable to take into consideration as to how the vehicle control or the notification of messages to the driver is performed in the case in which the use of detection results of some of the sensors is suspended.

### DISCLOSURE OF THE INVENTION

According to one aspect of the invention, there is provided an improved wheel-state estimation device in which the above-mentioned problems are eliminated.

According to one aspect of the invention, there is provided a wheel-state estimation device which is adapted to suitably carry out processing of a force or acceleration acting on a wheel, even when use of the detection result of one or more sensors for detecting the force or acceleration acting on the wheel is suspended.

According to one aspect of the invention, there is provided a vehicle control device which is adapted to suitably carry out processing of a force or acceleration acting on a wheel, even when use of the detection result of one or more sensors for detecting the force or acceleration acting on the wheel is suspended.

In an embodiment of the invention which solves or reduces one or more of the above-mentioned problems, there is provided a wheel-state estimation device which estimates a force or acceleration acting on a wheel provided in an automotive vehicle, the wheel-state estimation device comprising: a plurality of wheel side detection units respectively provided in a plurality of wheels of the vehicle, each wheel side detecting unit detecting a force or acceleration acting on a corresponding one of the wheels; and an estimation unit estimating, when use of detection results of one of the wheels from one of the plurality of wheel side detection units is suspended, a force or acceleration acting on the one of the wheels with respect to the suspended use of the detection results, by using detection results of other wheels from other wheel side detection units.

The above-mentioned wheel-state estimation device may be configured so that the plurality of wheel side detection units are respectively provided in four wheels of the vehicle, and the estimation unit is configured to estimate, when use of detection results of one of the four wheels from one of the plurality of wheel side detection units is suspended, a force or acceleration acting on the one of the four wheels with respect to the suspended use of the detection results, by using detection results of other wheels from other wheel side detection units.

The above-mentioned wheel-state estimation device may be configured so that, when S1 denotes a force or acceleration acting on the one of the four wheels with respect to the suspended use of the detection results, S2 and S3 respectively denote forces or accelerations acting on wheels of the four wheels which are located adjacent to the one of the four wheels, and S4 denotes a force or acceleration acting on a wheel of the four wheels which is located diagonally opposite to the one of the four wheels, the estimation unit is configured to estimate the force or acceleration S1 by using the formula S1=(S2×S3)/S4.

In an embodiment of the invention which solves or reduces one or more of the above-mentioned problems, there is provided a vehicle control device which is adapted to control an automotive vehicle, the vehicle control device comprising; a plurality of wheel side detection units respectively provided in a plurality of wheels of the vehicle, each wheel side detecting unit detecting a force or acceleration acting on a corresponding one of the wheels; an estimation unit estimating, when use of detection results of one of the wheels from one of the plurality of wheel side detection units is suspended, a force or acceleration acting on the one of the wheels with respect to the suspended use of the detection results, by using detection results of other wheels from other wheel side detection units; a braking force determination unit determining a target braking force to be exerted on each wheel, by using the detected force or acceleration and the estimated force or acceleration; and a braking control unit controlling a braking force on each wheel so as to conform to the determined target braking force.

In an embodiment of the invention which solves or reduces one or more of the above-mentioned problems, there is provided a vehicle control device which is adapted to control an automotive vehicle, the vehicle control device comprising: a plurality of wheel side detection units respectively provided in a plurality of wheels of the vehicle, each wheel side detecting unit detecting a force or acceleration acting on a corresponding one of the wheels; an estimation unit estimating, when use of detection results of one of the wheels from one of the plurality of wheel side detection units is suspended, a force or acceleration acting on the one of the wheels with respect to the suspended use of the detection results, by using detection results of other wheels from other wheel side detection units; a driving force determination unit determining a target driving force to drive each wheel, by using the detected force or acceleration and the estimated force or acceleration; and a drive control unit controlling a driving force which drives each wheel so as to conform to the determined target driving force.

In an embodiment of the invention which solves or reduces one or more of the above-mentioned problems, there is provided a wheel-state estimation device which estimates a force or acceleration acting on a wheel provided in an automotive vehicle, the wheel-state estimation device comprising: a body side detection unit detecting a force or acceleration acting on a body of the vehicle; a plurality of wheel side detection units respectively provided in a plurality of wheels of the vehicle, each wheel side detecting unit detecting a force or acceleration acting on a corresponding one of the wheels; and an estimation unit estimating, when use of detection results of one of the wheels from one of the plurality of wheel side detection units is suspended, a force or acceleration acting on the one of the wheels with respect to the suspended use of the detection results, by using detection results of the body from the body side detection unit.

The above-mentioned wheel-state estimation device may be configured so that the body side detection unit comprises a stroke quantity detection unit provided for each of a plurality of suspensions, which are respectively disposed between the wheels and the body, to detect a stroke quantity of a corresponding one of the plurality of suspensions, and the estimation unit is configured to estimate, when use of detection results of one of the wheels from one of the plurality of wheel side detection units is suspended, a force or acceleration acting on the one of the wheels with respect to the suspended use of the detection results, by using detection results of the suspensions from the stroke quantity detection units.

In an embodiment of the invention which solves or reduces one or more of the above-mentioned problems, there is provided a vehicle control device which is adapted to control an automotive vehicle, the vehicle control device comprising: a body side detection unit detecting a force or acceleration acting on a body of the vehicle; a plurality of wheel side detection units respectively provided in a plurality of wheels of the vehicle, each wheel side detecting unit detecting a force or acceleration acting on a corresponding one of the wheels; an estimation unit estimating, when use of detection results of one of the wheels from one of the plurality of wheel side detection units is suspended, a force or acceleration acting on the one of the wheels with respect to the suspended use of the detection results, by using detection results of the body from the body side detection unit; a braking force determination unit determining a target braking force to be exerted on each wheel, by using the detected force or acceleration and the estimated force or acceleration; and a braking control unit controlling a braking force on each wheel so as to conform to the determined target braking force.

In an embodiment of the invention which solves or reduces one or more of the above-mentioned problems, there is provided a vehicle control device which is adapted to control an automotive vehicle, the vehicle control device comprising: a body side detection unit detecting a force or acceleration acting on a body of the vehicle; a plurality of wheel side detection units respectively provided in a plurality of wheels of the vehicle, each wheel side detecting unit detecting a force or acceleration acting on a corresponding one of the wheels; an estimation unit estimating, when use of detection results of one of the wheels from one of the plurality of wheel side detection units is suspended, a force or acceleration acting on the one of the wheels with respect to the suspended use of the detection results, by using detection results of the body from the body side detection unit; a driving force determination unit determining a target driving force to drive each wheel, by using the detected force or acceleration and the estimated force or acceleration; and a drive control unit controlling a driving force which drives each wheel so as to conform to the determined target driving force.

In an embodiment of the invention which solves or reduces one or more of the above-mentioned problems, there is provided a wheel-state estimation device which estimates a force or acceleration acting on a wheel provided in an automotive vehicle, the wheel-state estimation device comprising: a body side detection unit detecting a force or acceleration acting on a body of the vehicle; a plurality of wheel side detection units respectively provided in a plurality of wheels of the vehicle, each wheel side detecting unit detecting a force or acceleration acting on a corresponding one of the wheels; and an estimation unit estimating, when use of detection results of some of the wheels from some of the plurality of wheel side detection units is suspended, a force or acceleration acting on each of some of the wheels with respect to the suspended use of the detection results, by using detection results of the body from the body side detection unit.

The above-mentioned wheel-state estimation device may be configured so that the body side detection unit comprises a stroke quantity detection unit provided for each of a plurality of suspensions, which are respectively disposed between the wheels and the body, to detect a stroke quantity of a corresponding one of the plurality of suspensions, and the estimation unit is configured to estimate, when use of detection results of one of the wheels from one of the plurality of wheel side detection units is suspended, a force or acceleration acting on each of some of the wheels with respect to the suspended-use of the detection results, by using detection results of the suspensions from the stroke quantity detection units.

In an embodiment of the invention which solves or reduces one or more of the above-mentioned problems, there is provided a vehicle control device which is adapted to control an automotive vehicle, the vehicle control device comprising: a body side detection unit detecting a force or acceleration acting on a body of the vehicle; a plurality of wheel side detection units respectively provided in a plurality of wheels of the vehicle, each wheel side detecting unit detecting a force or acceleration acting on a corresponding one of the wheels; an estimation unit estimating, when use of detection results of some of the wheels from some of the plurality of wheel side detection units is suspended, a force or acceleration acting on each of some of the wheels with respect to the suspended use of the detection results, by using detection results of the body from the body side detection unit; a braking force determination unit determining a target braking force to be exerted on each wheel, by using the detected force or acceleration and the estimated force or acceleration; and a braking control unit controlling a braking force on each wheel so as to conform to the determined target braking force.

In an embodiment of the invention which solves or reduces one or more of the above-mentioned problems, there is provided a vehicle control device which is adapted to control an automotive vehicle, the vehicle control device comprising: a body side detection unit detecting a force or acceleration acting on a body of the vehicle; a plurality of wheel side detection units respectively provided in a plurality of wheels of the vehicle, each wheel side detecting unit detecting a force or acceleration acting on a corresponding one of the wheels; an estimation unit estimating, when use of detection results of some of the wheels from some of the plurality of wheel side detection units is suspended, a force or acceleration acting on each of some of the wheels with respect to the suspended use of the detection results, by using detection results of the body from the body side detection unit; a driving force determination unit determining a target driving force to drive each wheel, by using the detected force or acceleration and the estimated force or acceleration; and a drive control unit controlling a driving force which drives each wheel so as to conform to the determined target driving force.

According to the embodiments of the wheel-state estimation device and the vehicle control device of the invention, even when use of the detection result of one or more sensors for detecting the force or acceleration acting on the wheel is suspended, it is possible to carry out suitably the processing of the force or acceleration acting on the wheel.

### BRIEF DESCRIPTION OF THE DRAWINGS

FIG. 1 is a diagram showing the outline composition of an automotive vehicle in which a vehicle control device in an embodiment of the invention is provided.

FIG. 2 is a partial cross-sectional view of a wheel in the vehicle in which the vehicle control device in an embodiment of the invention is provided.

FIG. 3 is a diagram showing the arrangement of acceleration sensors in a tire in an embodiment of the invention of the invention.

FIG. 4 is a block diagram showing the composition of the vehicle control device in an embodiment of the invention.

FIG. 5 is a diagram for explaining the relation between the tire grounding condition and the acceleration waveform obtained from detection values of acceleration sensors provided in the tire.

FIG. 6 is a flowchart for explaining the processing performed by the vehicle control device in an embodiment of the invention.

FIG. 7 is a diagram for explaining a vertical force and a lateral force when a malfunction occurs in the acceleration sensors of the front left tire of the vehicle in which the vehicle control device in an embodiment of the invention is provided.

FIG. 8 is a flowchart for explaining the processing performed by the vehicle control device in an embodiment of the invention.

FIG. 9 is a flowchart for explaining the processing performed by the vehicle control device in an embodiment of the invention.

FIG. 10 is a partial cross-sectional view of the wheel in the vehicle in which the vehicle control device in an embodiment of the invention is provided.

### BEST MODE FOR CARRYING OUT THE INVENTION

A description will now be given of an embodiment of the invention with reference to the accompanying drawings.

### 1st Embodiment

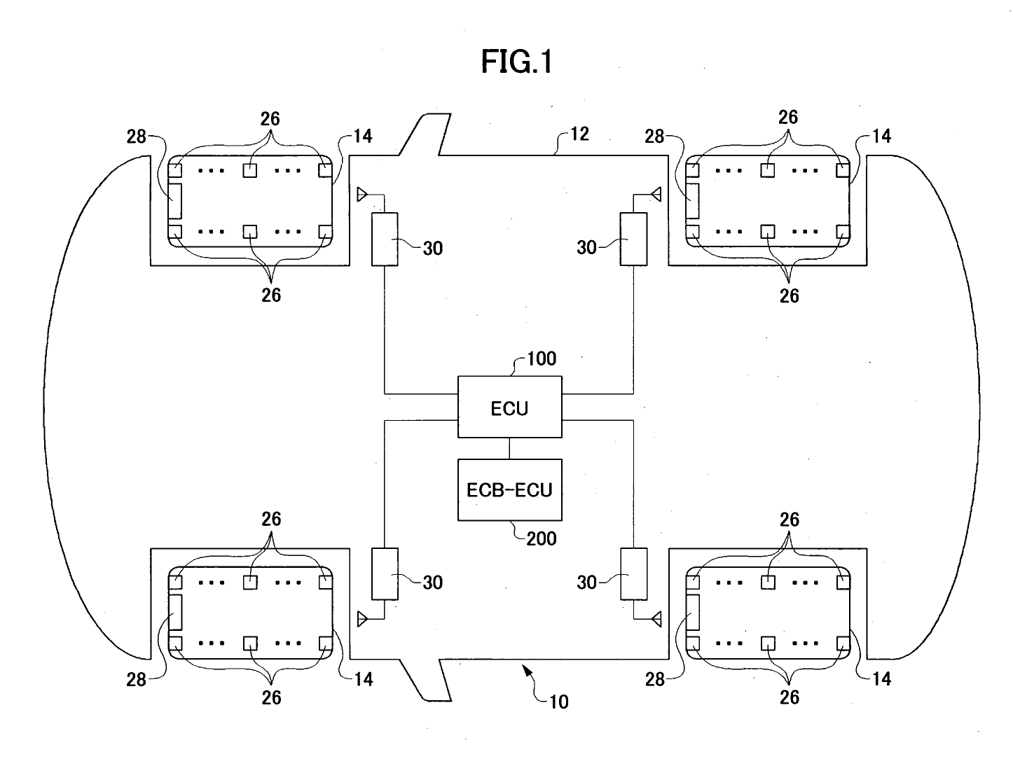

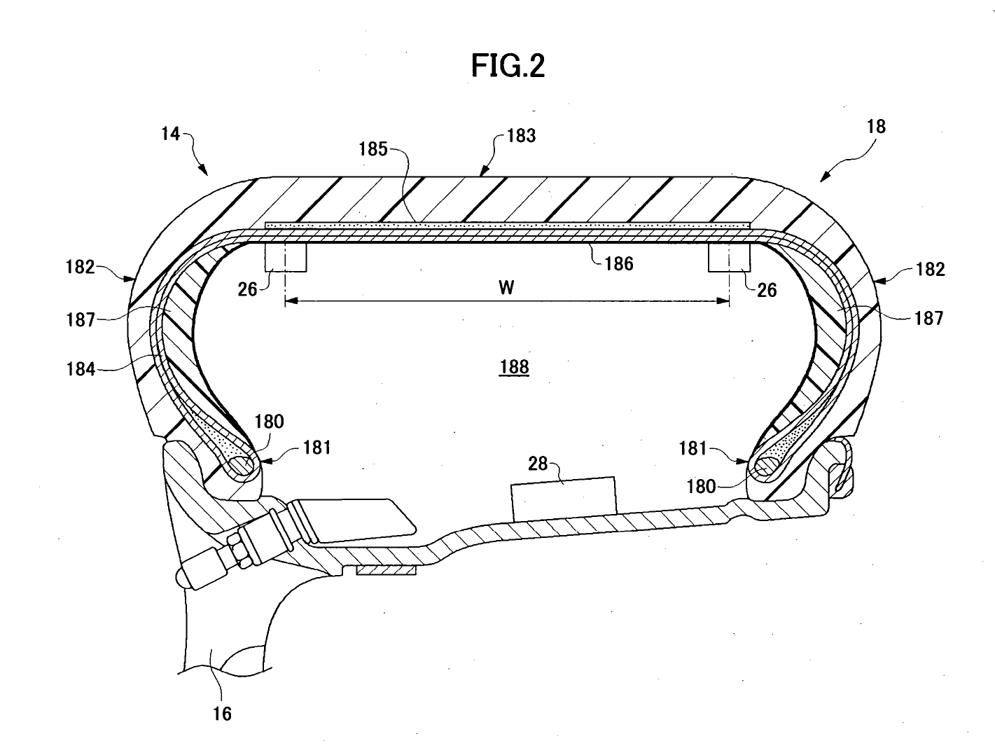

FIG. 1 shows the outline composition of an automotive vehicle in which a vehicle control device in the 1st embodiment of the invention is provided. FIG. 2 is a partial cross-sectional view of a wheel in the vehicle in which the vehicle control device in the 1st embodiment of the invention is provided.

As shown in FIG. 1, the vehicle control device comprises an electronic control unit (ECU) 100, an ECB (Electronically Controlled Brake System)-ECU 200, body side transceivers 30, wheels 14, and acceleration sensors 26 and a transmitter 28 which are provided in each wheel 14. The vehicle 10 shown in FIG. 1 is provided with the four wheels 14 provided in a body 12, a steering device (which is not illustrated) which steers the steering wheel to turn the two of the wheels 14, a driving source (which is not illustrated) which drives the driving wheels of the four wheels 14, and a braking device (which is not illustrated).

Each wheel 14 includes a wheel part 16 and a tire 18, respectively. In this embodiment, a run-flat tire is used as the tire 18 which constitutes the wheel 14. Alternatively, a general-purpose hollow tire other than the run-flat tire may be used as the tire 18.

As shown in FIG. 2, the tire 18 in this embodiment is a side reinforcement type run-flat tire, and a run flat operating state of the tire 18 is attained even at the time of a fall of the tire air pressure.

As shown in FIG. 2, the tire 18 contains a pair of bead parts 181 in which a bead core 180 is included, a pair of sidewall parts 182 extending outward in the tire radial direction from the bead parts 181, and a tread part 183 extending between the sidewall parts 182.

A carcass 184, which is made of, for example, a sheet of a fiber material, is embedded in the bead parts 181, the sidewall parts 182, and the tread part 183. A belt layer 185 is embedded in the tread part 183 so that the belt layer 185 is located in the outside of the carcass 184. A reinforcing rubber 187 is embedded in each of the sidewall parts 182 so that the reinforcing rubber 187 is located inside an inner liner 186.

Each of the reinforcing rubbers 187 has a large rigidity, and when the air pressure in the tire interior space 188 formed by the wheel part 16 and the tire 18 falls due to blowout or the like, the rubbers 187 function to attain a run flat operating condition of the vehicle by supporting the whole tire 18 to the wheel part 16.

In addition, the tire 18 provided in the vehicle 10 is not limited to the side reinforcement type run-flat tire. Alternatively, the tire 18 may be an inside core type run-flat tire provided with the inside core for supporting the whole tire 18 to the wheel part 16 when the air pressure in the tire interior space 188 falls.

As shown in FIG. 1 and FIG. 2, each of the above-mentioned wheels 14 is provided with a plurality of acceleration sensors 26, respectively. Each of the acceleration sensors 26 is fixed to the inside surface of the tread part 183 of the tire 18 as shown in FIG. 2. Each acceleration sensor 26 detects an acceleration acting on the wheel at a corresponding installation location in the peripheral direction of the tire 18 as wheel information, respectively.

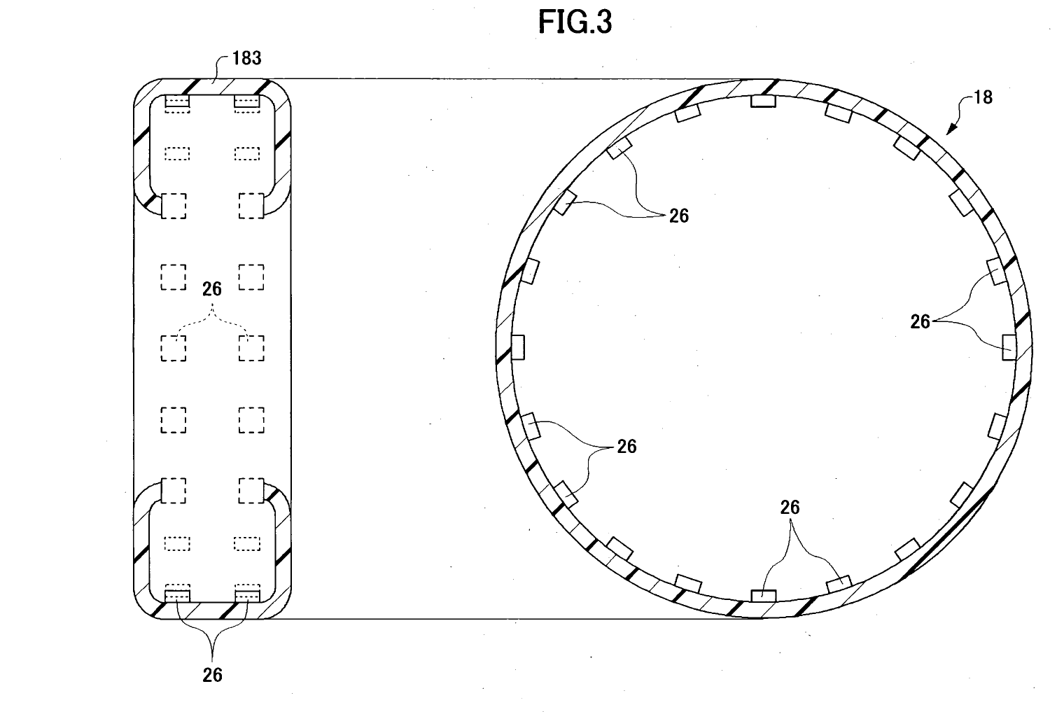

FIG. 3 shows the arrangement of acceleration sensors in a tire in the 1st embodiment of the invention. As shown in FIG. 3, the plurality of acceleration sensors 26 are disposed in the tire peripheral direction on the inside surface of the tread part 183, and they are arranged in two or more rows in the tire width direction. In this embodiment, a total of 20 acceleration sensors 26 are arranged on the inside surface of the tread part 183 at intervals of 18 degrees in the tire peripheral direction.

Alternatively, a strain gage may be provided in a wheel instead of an acceleration sensor, and an acceleration acting on the wheel may be computed through differentiation calculation of the amount of strain, which is the output value of the strain gage, by the ECU 100 provided on the body 12.

In this embodiment, the acceleration sensors 26 are arranged in two rows which are separated by an interval W in the tire width direction, and the acceleration sensors 26 of the tire outside row are adjacent to the acceleration sensors 26 of the tire inside row in the tire width direction respectively.

In addition, each of the acceleration sensors 26 may be provided to detect an acceleration acting on the wheel at a corresponding installation location in the tire diameter direction as wheel information. Alternatively, three or more rows of acceleration sensors 26 may be arranged in the tire 18 of each wheel 14.

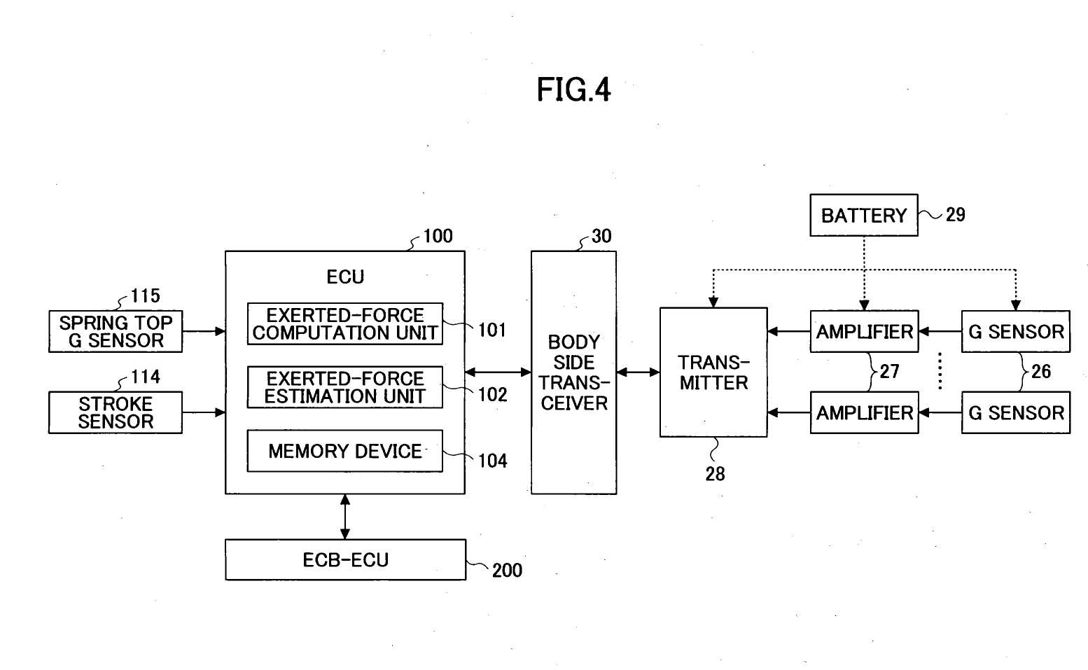

FIG. 4 shows the composition of the wheel-state estimation device in the 1st embodiment of the invention.

The acceleration sensors 26 provided in the tire 18 are connected to a transmitter 28 via amplifiers 27, respectively. A battery 29, which supplies electric power to the acceleration sensors 26, the amplifier 27, and the transmitter 28, is provided in each of the wheels 14.

In this embodiment, a single transmitter 28 is assigned for all the 20 acceleration sensors 26 and the 20 amplifiers 27 in each wheel 14. The amplifiers 27, the transmitter 28, and the battery 29 are arranged at appropriate locations of the corresponding wheel 14, for example, on the peripheral surface of the wheel part 16. Each amplifier 27 amplifies the output signal of the corresponding acceleration sensor 26, and supplies the amplified signal to the transmitter 28. The transmitter 28 transmits, through the wireless transmission method, the signal indicating the output signal of the acceleration sensor 26 as the wheel information at intervals of a given time which is on the order of 1-20 msec.

As shown in FIG. 1 and FIG. 4, a plurality of body side transceivers 30 (in this embodiment, four transceivers) are arranged in the body 12 of the vehicle 10 so that each transceiver 30 corresponds to one of the wheels 14. Each of the body side transceivers 30 is adapted to transmit or receive the signal indicating the wheel information, to or from the transmitters 28 provided in the corresponding wheel 14.

Alternatively, a single body side transceiver may be arranged in the body 12 so that it is adapted to transmit or receive the signal indicating the wheel information to or from the transmitters 28 provided in each wheel 14.

As shown in FIG. 1 and FIG. 4, each of the body side transceivers 30 is connected to the ECU 100 provided in the body 12. Each of the body side transceivers 30 receives the information sent from the corresponding transmitter 28 of the wheel 14 by the wireless transmission method, and inputs the received information to the ECU 100.

The information received from the transmitters 28 in this manner is sequentially stored or accumulated in the memory device (which will be described later) of the ECU 100. The ECU 100 carries out various kinds of control processing by using the information received from each of the body side transceivers 30.

As shown in FIG. 4, the plurality of sensors are connected to the ECU 100. Among the sensors connected to the ECU 100, a stroke sensor 114 and a spring top G sensor 115 are included. The spring top G sensor 115 detects the acceleration in the width direction and/or sliding direction of the spring-top body which is connected to the wheel 14 via the suspension, as being the spring-top vibration of the vehicle 10.

The stroke sensor 114 detects the stroke quantity which is the elastic length of the suspension connected between the body 12 and the wheel 14. The stroke sensor 114 may be directly disposed on the suspension to detect the stroke quantity. In addition, a vehicle height sensor one end of which is connected to the lower arm to detect the relative displacement of the spring top body and the spring bottom body may be used as the stroke sensor 114.

The spring top G sensor 115 and the stroke sensor 114 are connected to the ECU 100, and the detection results of these sensors are inputted to the ECU 100.

In cooperation with the ECU which controls the running drive source and the ECU which controls the steering device in the above-described vehicle 10, the ECB-ECU 200 (refer to FIG. 1) which controls the braking device (electronic control type braking device) carries out integrated control of driving, steering and braking of the vehicle 10 (VDIM: Vehicle Dynamics Integrated Management) in order to stabilize the running behavior of the vehicle 10. From a viewpoint of performing vehicle kinematic control with high precision when carrying out the integrated control, it is required to acquire, with a sufficiently high level of accuracy, the lateral force in the wheel width direction and the vertical force (or the load in the wheel height direction) acting on each of the tires 18.

For this reason, as shown in FIG. 4, the ECU 100 comprises an exerted-force computation unit 101 which computes the lateral force and the vertical force which act on the grounding surface of each of the tires 18 by using the detection results of the acceleration sensors 26.

Moreover, the ECU 100 comprises an exerted-force estimation unit 102 in addition to the exerted-force computation unit 101. The exerted-force estimation unit 102 of this embodiment uses the forces acting on the grounding surfaces of at least two tires 18 computed by the exerted-force computation unit 101, and estimates the lateral force which acts on the grounding surface of each of other tires 18. Furthermore, the exerted-force estimation unit 102 of this embodiment estimates the vertical force acting on the grounding surface of each of other tires 18 by using a predetermined correlation formula.

The ECU 100 further comprises a memory device 104. The memory device 104 includes a ROM storing various control programs, a RAM used as the work area for data storage and program execution, and a nonvolatile rewritable memory, such as a flash memory. Various coefficients used for computation of the vertical force and the lateral force by the exerted-force computation unit 101, the values of the above-mentioned correlation formula used for wheel force estimation by the exerted-force estimation unit 102, etc. are stored in the memory device 104. Therefore, the ECU 100 including the exerted-force estimation unit 102 functions as an estimation unit which estimates the forces acting on the wheels where the vehicle is grounded.

The exerted-force computation unit 101 determines an interval Δt of time between the peaks of the acceleration waveform acquired from the detection values of the acceleration sensors 26, based on the acceleration information as the detection results of the acceleration sensors 26 provided in the tire 18.

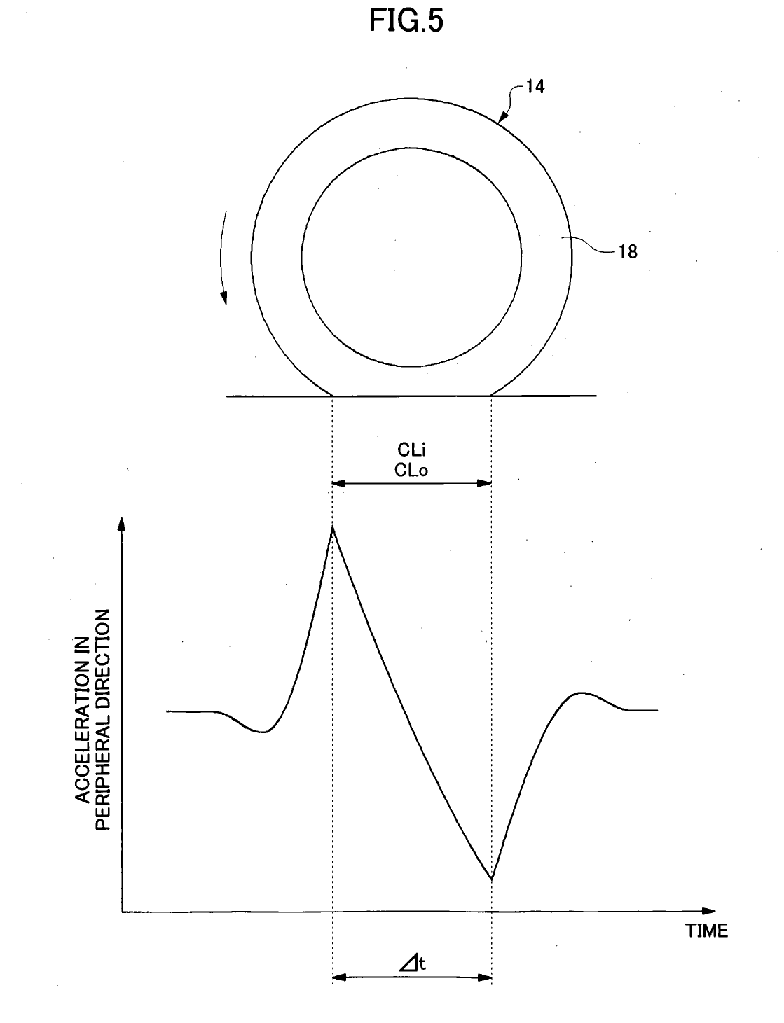

As described above, each of the acceleration sensors 26 detects the acceleration in the peripheral direction of the tire 18 at the corresponding installation location. Therefore, as shown in FIG. 5, when the tread part 183 corresponding to the part where the acceleration sensor 26 is arranged comes in contact with the road surface (i.e., when the acceleration sensor 26 is located near the front edge of the grounding part of the tire 18), the signal which indicates a large acceleration value (peak value) is outputted by the acceleration sensor 26. Similarly, when the tread part 183 corresponding to the part where the acceleration sensor 26 is arranged is separated from the road surface (i.e., when the acceleration sensor 26 is located near the rear edge of the grounding part of the tire 18), the signal which indicates a large acceleration value (peak value) is outputted by the acceleration sensor 26.

For this reason, the exerted-force computation unit 101 computes the interval Δt of time between the peaks of the above-mentioned acceleration waveform, based on the sampling time of acceleration sensor 26 or the number of data samples between the peaks of the acceleration waveform.

After the interval Δt is computed, the exerted-force computation unit 101 computes a grounding length CL of the tire 18 of the corresponding wheel 14 in the fore-and-aft direction of the vehicle, based on the interval Δt, the wheel speed indicated by the output signal of a wheel speed sensor of the corresponding wheel 14, the predetermined tire radius, etc. Since the acceleration sensors 26 of each tire 18 of the wheels 14 in this embodiment are arranged in two rows, a grounding length CLi is computer based on the interval Δt which is computed based on the output signals of the acceleration sensors 26 of the tire inside row, while a grounding length CLo is computed based the interval Δt which is computed based on the output signals of the acceleration sensors 26 of the tire outside row.

After the tire inside grounding length CLi and the tire outside grounding length CLo of the tire 18 in the vehicle fore-and-aft direction are computed, the exerted-force computation unit 101 computes a lateral force Fx acting on the grounding surface of the tire 18 in the tire width direction, based on the ratio of the tire inside grounding length CLi and the tire outside grounding length CLo of the tire 18 in the vehicle fore-and-aft direction.

Namely, when the acceleration sensors 26 are arranged in the tire 18 in a plurality of rows (two rows) in the tire width direction as mentioned above, the grounding lengths CLi and CLo of the tire 18 in the vehicle fore-and-aft direction which are computed for every row of acceleration sensors 26 vary according to the magnitude of lateral force Fx which acts on the grounding surface of the tire 18. Therefore, if the ratio of the grounding lengths CLi and CLo is given, it is possible to determine the lateral force Fx in the wheel width direction which acts on the grounding surface of the tire 18 with a sufficiently high level of accuracy.

In this embodiment, the map or correlation formula which defines the correlation between the ratio of the tire inside grounding length CLi and the tire outside grounding length CLo and the lateral force Fx is predetermined and stored in the memory device 104, and the exerted-force computation unit 101 acquires the lateral force Fx by using the map or correlation formula. Such map or correlation formula is created beforehand on the basis of the time the vehicle 10 is maneuvered during a steady running condition of the vehicle 10 (during a fixed-speed running).

In this embodiment, the plurality of acceleration sensors 26 are arranged on the inside surface of the tread part 183 of the tire 18, and the acceleration of the tire 18 in the tire peripheral direction or tire radial direction is detected. Change of the acceleration of the tire 18 in the tire peripheral direction or tire radial direction is monitored, and it is possible to compute a grounding length CL of the tire 18 in the vehicle fore-and-aft direction with a sufficiently high level of accuracy, based on the interval Δt of time between the peaks of the acceleration waveform.

Once the tire inside grounding length CLi and the tire outside grounding length CLo of the tire 18 in the vehicle fore-and-aft direction are computed, the exerted-force computation unit 101 computes a vertical force Fz acting on the grounding surface of the tire 18 in the wheel height direction, based on the average value of the tire inside grounding length CLi and the tire outside grounding length CLo of the tire 18 in the vehicle fore-and-aft direction. The grounding lengths CLi and CLo in the vehicle fore-and-aft direction of the tire 18 vary according to the magnitude of the vertical force Fz acting on the grounding surface of the tire 18.

In this embodiment, the lateral force of the tire 18 is computed by using the two-row arrangement of acceleration sensors 26 in the tire 18 as mentioned above. There may be a case in which the grounding lengths CLi and CLo may differ from each other. However, if the average value of the grounding lengths CLi and CLo is given, it is possible to determine the vertical force Fz acting in the wheel height direction on the grounding surface of the tire 18 with sufficient accuracy.

In this embodiment, a map or correlation formula which defines the correlation of the average value of the tire inside length CLi and the tire outside grounding length CLo with the vertical force Fz is predetermined and stored in the memory device 104, and the exerted-force computation unit 101 acquires a vertical force Fz by using the map or correlation formula. Such map or correlation formula is created beforehand on the basis of the time the vehicle 10 is maneuvered during a steady running condition of the vehicle 10. Thus, the acceleration sensor 26 is provided in the wheel 14 and functions as a wheel side detection unit which detects the force acting on the wheel 14.

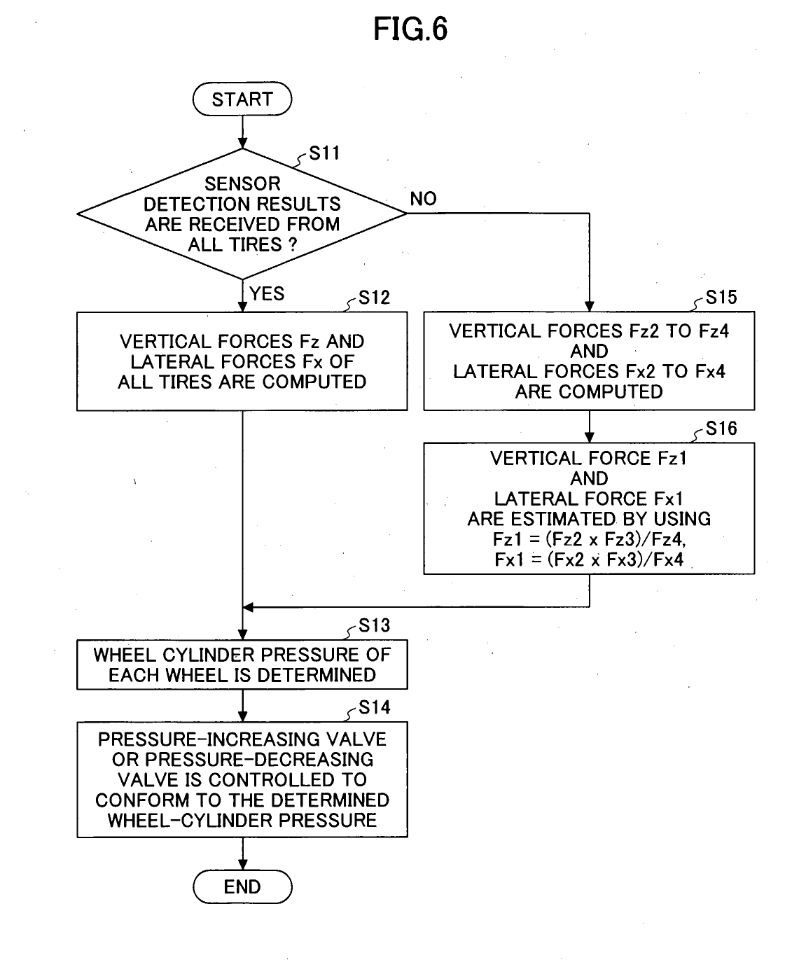

FIG. 6 is a flowchart for explaining the processing performed by the vehicle control device in the 1st embodiment of the invention.

The processing in the flowchart of FIG. 6 is started when the ignition key of the vehicle is turned ON by the user and power is supplied to the ECU 100, and thereafter it is repeatedly performed at intervals of a predetermined time.

As shown in FIG. 6, the ECU 100 determines whether the detection results of acceleration sensors 26 are received from all the tires 18 (S11). When the detection results are received from all the tires 18 and they are available to the ECU 100, the exerted-force computation unit 101 determines that no malfunction occurs in any of the acceleration sensors 26, the amplifiers 27, and the transmitters 28, and computes a vertical force Fz and a lateral force Fx which act on each of the tires 18, by using the received detection results (S12).

If the detection results of acceleration sensors 26 cannot be received from one tire 18 among the four tires 18 and they are not available to the ECU 100 at S11, the exerted-force computation unit 101 determines that a malfunction occurs in any of the acceleration sensors 26, the amplifiers 27 and the transmitter 28, which are provided in the tire 18 from which the detection results of acceleration sensors 26 cannot be received. And the exerted-force computation unit 101 suspends use of the detection results of the acceleration sensors 26 from the tire concerned.

In the following, suppose that Fz1 denotes the vertical force acting on the tire 18 with respect to the suspended use of the detection results of acceleration sensor 26, and Fx1 denotes the lateral force thereof. Moreover, suppose that Fz2 and Fz3 respectively denote the vertical forces acting on the tires 18 among the four tires 18 which are located adjacent to the tire 18 with respect to the suspended use of the detection results, and Fx2 and Fx3 respectively denote the lateral forces thereof. Moreover, suppose that Fz4 denotes the vertical force acting on the tire 18 among the four tires 18 which is located diagonally opposite to the tire 18 with respect to the suspended use of the detection results, and Fx4 denotes the lateral force thereof.

The exerted-force computation unit 101 computes the vertical forces Fz2, Fz3 and Fz4 acting on the remaining three tires 18 with which the use of the detection results of acceleration sensors 26 can be continued, by using the received detection results of acceleration sensors 26. And the exerted-force computation unit 101 computes the lateral forces Fx2, Fx3 and Fx4 acting on the tires 18 with which the use of the detection results of acceleration sensors 26 can be continued, by using the received detection results of acceleration sensors 26 (S15).

After the vertical forces Fz2 to Fz4 and the lateral forces Fx2 to Fx4 are computed, the exerted-force estimation unit 102 estimates the vertical force Fz1 and the lateral force Fx1 acting on the tire 18 with respect to the suspended use of the detection results of acceleration sensors 26, in accordance with the formulas:

Fz1=(Fz2×Fz3)/Fz4 and Fx1=(Fx2×Fx3)/Fx4 (S16).

Generally speaking, the ratio of the vertical force Fz and the lateral force Fx acting on each of the wheels 14 of the vehicle 10 is governed by the proportional relation, that is, the front left wheel:the front right wheel=the rear left wheel:the rear right wheel. For this reason, even when the use of the detection results of acceleration sensors 26 of one wheel 14 is suspended, it is possible to estimate the vertical force Fz and the lateral force Fx acting on the wheel 14 with respect to the suspended use of the detection results of acceleration sensors 26, in accordance with the above-mentioned formulas.

Thus, the vertical force Fz and the lateral force Fx which act on the grounding surface of the tire 18 can be estimated through simple computation, and it is possible to effectively reduce the burdens needed for the design of the ECU 100 and the controlling processing of the ECU 100.

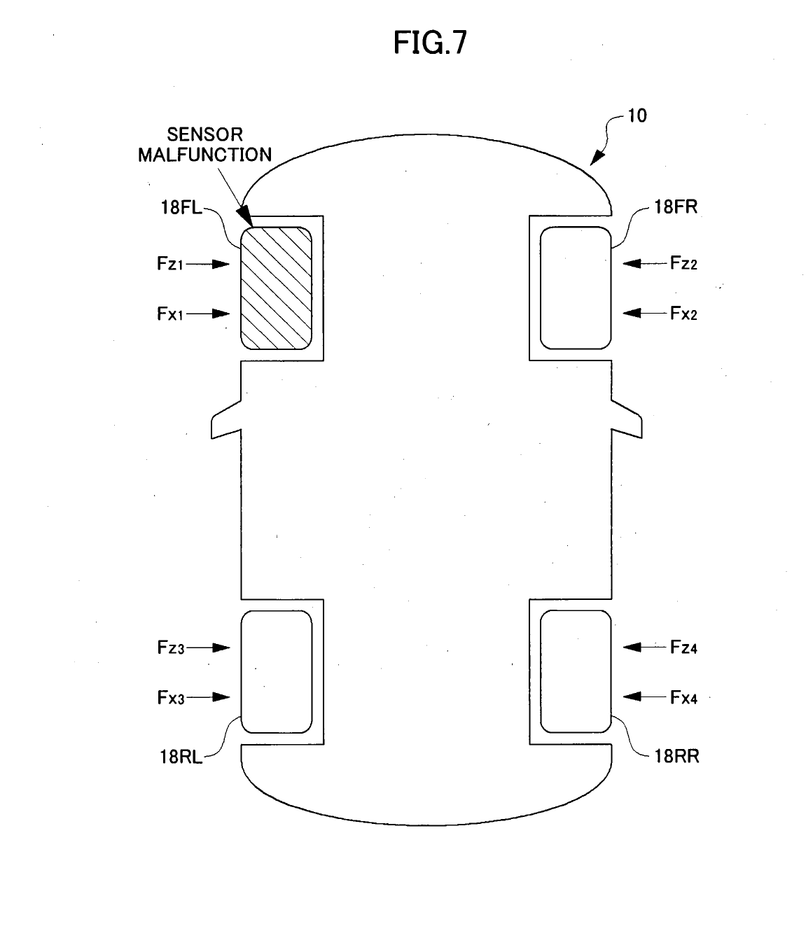

For example, suppose that a malfunction occurs in the acceleration sensors 26 of the front left wheel tire 18FL as shown in FIG. 7. In this case, the use of the detection results of acceleration sensors 26 of the front left wheel tire 18FL is suspended and the use of the detection results of acceleration sensors 26 of the front right wheel tire 18FR, the rear left wheel tire 18RL and the rear right wheel tire 18RR is continued. And suppose that Fz1 denotes the vertical force acting on the front left wheel tire 18FL, and Fx1 denotes the lateral force thereof. Also suppose that Fz2 denotes the vertical force acting on the front right wheel tire 18FR, Fx2 denotes the lateral force acting on the front right wheel tire 18FR (which is located adjacent to the tire 18FL), Fz3 denotes the vertical force acting on the rear left wheel tire 18RL (which is located adjacent to the tire 18FL), Fx3 denotes the lateral force acting on the rear left wheel tire 18RL, Fz4 denotes the vertical force acting on the rear right wheel tire 18RR (which is located diagonally opposite to the tire 18FL), and Fx4 denotes the lateral force acting on the rear right wheel tire 18RR.

For example, if the computed vertical force Fz2 of the front right wheel tire 18FR is 500 kgf, the computed vertical force Fz3 of the rear left wheel tire 18RL is 400 kgf, and the computed vertical force Fz4 of the rear right wheel tire 18RR is 400 kgf, then the exerted-force estimation unit 102 estimates the vertical force Fz1 of the front left wheel tire 18FL as being Fz1=(500 kgf)×(400 kgf)/(400 kgf)=500 kgf. For example, if the computed lateral force Fx2 of the front right wheel tire 18FR is 500 kgf, the computed lateral force Fx3 of the rear left wheel tire 18RL is 400 kgf, and the computed lateral force Fx4 of the rear right wheel tire 18RR is 500 kgf, then the exerted-force estimation unit 102 estimates the lateral force Fx1 of the front left wheel tire 18FL as being Fx1=(500 kgf)×(400 kgf)/(500 kgf)=400 kgf.

After the processing of step S12 or step S16 is performed, the ECU 100 determines the wheel cylinder pressure of each wheel 14 by using the computed/estimated vertical forces Fz and lateral forces Fx (S13). Therefore, the ECU 100 functions as a braking force determination unit which determines a target braking force to be exerted on each wheel, by using the detected vertical force or lateral force and the estimated vertical force or lateral force.

After the wheel cylinder pressure of each wheel 14 is determined, the ECU 100 supplies the information which indicates the determined wheel cylinder pressure to the ECB-ECU 200. The ECB-ECU 200 uses the received information and controls the current supplied to the pressure-increasing valve or the pressure-decreasing valve in a hydraulic actuator of the braking device through the duty control, to control the opening/closing of the pressure-increasing valve or the pressure-decreasing valve so as to conform to the determined wheel cylinder pressure (S14). Therefore, the ECB-ECU 200 functions as a braking control unit which controls the braking force on each wheel 14 so as to conform to the determined braking force. Since the wheel cylinder pressure is adjusted, the braking force which is exerted on the wheels 14 by the brake device provided in each wheel 14 is adjusted.

Accordingly, in a vehicle which carries out attitude control using the force or acceleration acting on the wheels, the force or acceleration acting on the wheel can be appropriately estimated even when the use of the detection results of the detection units of one of the wheels is suspended, and it is possible to realize stable attitude control of the vehicle.

The ECU 100 may be configured so that, when the use of the detection results of acceleration sensors 26 in two or more tires 18 is suspended, the ECU 100 suspends the attitude control which is performed using the force or acceleration acting on the wheels. In this case, the ECU 100 may be configured to carry out attitude control only based on the output values of the body side sensors provided in the body 12, such as acceleration sensors, like the spring top G sensor 115, yaw rate sensors, or vehicle wheel speed sensors.

Even in a steady running condition of the vehicle, there may be a case in which the ratio of the force acting on the front left wheel tire 18FL to the force acting on the front right wheel tire 18FR is not the same as the ratio of the force acting on the rear left wheel tire 18RL to the force acting on the rear right wheel tire 18RR, depending on the load distribution or loading situation of the vehicle. For example, it is a case where the vertical forces acting on the front left wheel tire 18FL, the rear left wheel tire 18RL, and the rear right wheel tire 18RR are 400 kgf, and the vertical force acting on the front right wheel tire 18FR is 420 kgf.

In order to take appropriate measures against such a case, the wheel-state estimation device in an embodiment of the invention is configured so that the values of the coefficient Kz included in the formula: Fz1=Kz×Fz2×Fz3/Fz4 and the coefficient Kx included in the formula: Fx1=Kx×Fx2×Fx3/Fx4 are stored beforehand, and the exerted-force estimation unit 102 estimates the vertical force Fz1 and the lateral force Fx1 of the tire 18 with respect to the suspended use of the detection results of acceleration sensors 26 using the two formulas and the stored values mentioned above.

Since the values of the coefficients are stored beforehand, the force or acceleration acting on the wheel can be estimated with a sufficiently high level of accuracy. The coefficients may be computed using the formulas: Kz=(Fz1×Fz4)/(Fz2×Fz3) and Kx=(Fx1×Fx4)/(Fx2×Fx3), under the condition in which the vehicle 10 is running straight on a flat road surface at a fixed speed and the detection result of acceleration sensors 26 of all the tires 18 are used continuously.

The exerted-force estimation unit 102 may be configured to acquire the coefficients at intervals of a predetermined time and store the acquired coefficients into the memory device 104. The exerted-force estimation unit 102 of this configuration can estimate the vertical force and the lateral force using the coefficients acquired beforehand, when the use of the detection results of one of the detection units is suspended. For example, even when the loading object loaded on the vehicle or its loading position changes, the force or acceleration acting on the wheel can be estimated with a sufficiently high level of accuracy.

### 2nd Embodiment

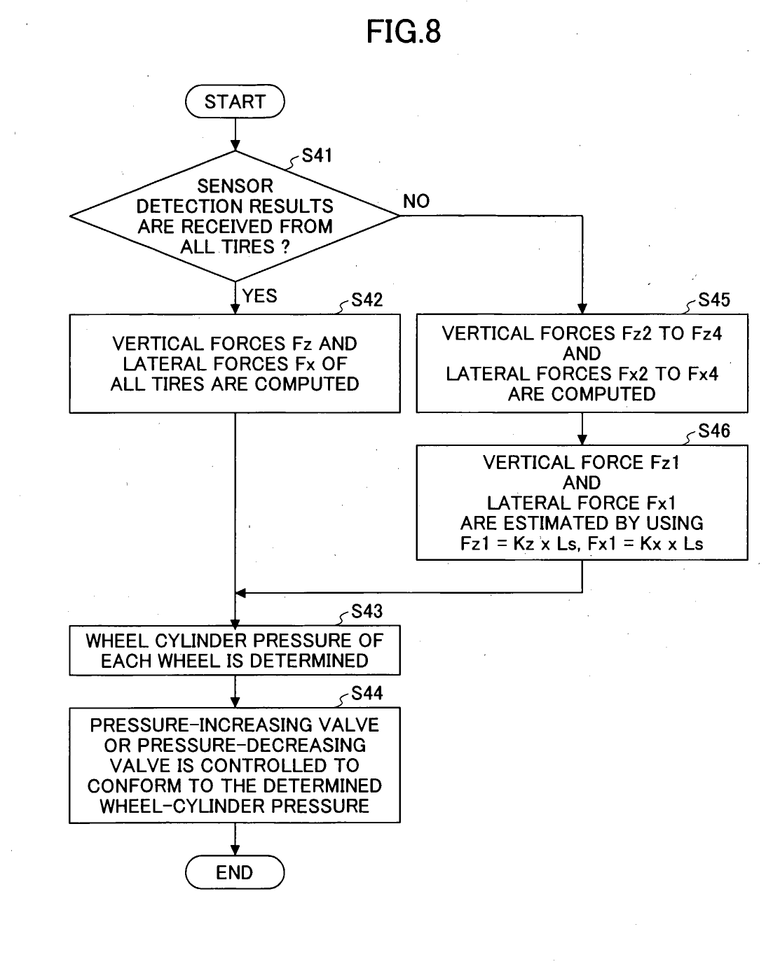

FIG. 8 is a flowchart for explaining the processing performed by the vehicle control device in the 2nd embodiment of the invention.

The composition of the vehicle control device in this embodiment is essentially the same as that of the 1st embodiment, and a description thereof will be omitted.

The processing in the flowchart of FIG. 8 is started when the ignition key of the vehicle is turned ON by the user and power is supplied to the ECU 100, and thereafter it is repeatedly performed at intervals of a predetermined time. The processing of steps S41 to S44 in FIG. 8 is essentially the same as that of steps S11 to S14 in FIG. 6, a description thereof will be omitted. It is supposed that the formulas for computing the vertical forces Fz1 to Fz4 and the lateral forces Fx1 to Fx4 in this embodiment are the same as those in the 1st embodiment.

When the detection results from one tire 18 among the four tires 18 are not received at S41, the exerted-force computation unit 101 determines that a malfunction occurs in any of acceleration sensor 26, amplifier 27, and transmitter 28, provided in the tire 18 from which the detection result is not received, and use of the detection result of the acceleration sensor 26 is suspended.

In this case, the exerted-force computation unit 101 computes vertical force Fz2, Fz3, and Fz4 of the tire 18 for the continued use of the detection results of acceleration sensor 26 by using the received acceleration information of the acceleration sensor 26.

The exerted-force computation unit 101 computes lateral force Fx2, Fx3, and Fx4 of the tire 18 for the continued use of the detection results of acceleration sensor 26 by using the acceleration information on received acceleration sensor 26 (S45).

The exerted-force estimation unit 102 computes stroke quantity Ls of the suspension which is provided to wheel 14 of the tire 18 with the suspended use of the detection results of acceleration sensor 26 among the four suspensions provided to the four wheels 14, and performs computation using the formulas: Fz1=Kz×Ls and Fx1=Kx×Ls, to estimate vertical force Fz1 and lateral force Fx1 which act on the tire 18 with the suspended use of the detection results of acceleration sensor 26 (S46).

The coefficients Kz and Kx for performing such computation are stored beforehand in the memory device 104, and the exerted-force estimation unit 102 estimates vertical force Fz1 and lateral force Fx1 by making reference to the stored coefficients Kz and Kx.

The formula for estimating the force acting on the tire 18, such as vertical force Fz1 and lateral force Fx1, may not be restricted to the above-mentioned formulas, and it is possible to estimate such force in accordance with other formulas using stroke quantity Ls. Also the mapping of the vertical force Fz1 and the lateral force Fx1 according to the stroke quantity Ls may be used.

Alternatively, the exerted-force estimation unit 102 may compute acceleration Az in the vertical direction of the vehicle body 12 from the detection results of the spring top G sensor 115, instead of stroke quantity Ls of stroke sensor 114, and may perform computation using the formulas Fz1=Kz×Az and Fx1=Kx×Az, to estimate vertical force Fz1 and lateral force Fx1 which act on the tire 18 with the suspended use of the detection results of acceleration sensor 26. The coefficients Kz and Kx for performing such computation are stored beforehand in the memory device 104, and the exerted-force estimation unit 102 may compute vertical force Fz1 and lateral force Fx1 by making reference to the stored coefficients Kz and Kx.

The vertical force Fz1 and lateral force Fx1 may not be restricted to the above-mentioned formula, but they may be computed by other formulas using the acceleration Az. Also the mapping of the vertical force Fz1 and the lateral force Fx1 according to the acceleration Az may be used.

In this embodiment, when the detection results are not received from two or more tires 18 among the four tires 18, the exerted-force estimation unit 102 estimates the force acting on each of such tires 18 from which the detection results of acceleration sensors 26 are not received, by using the detection results of the body side detection unit. The ECU 100 may be configured to suspend the attitude control which is performed using the force or acceleration acting on the wheel.

### 3rd Embodiment

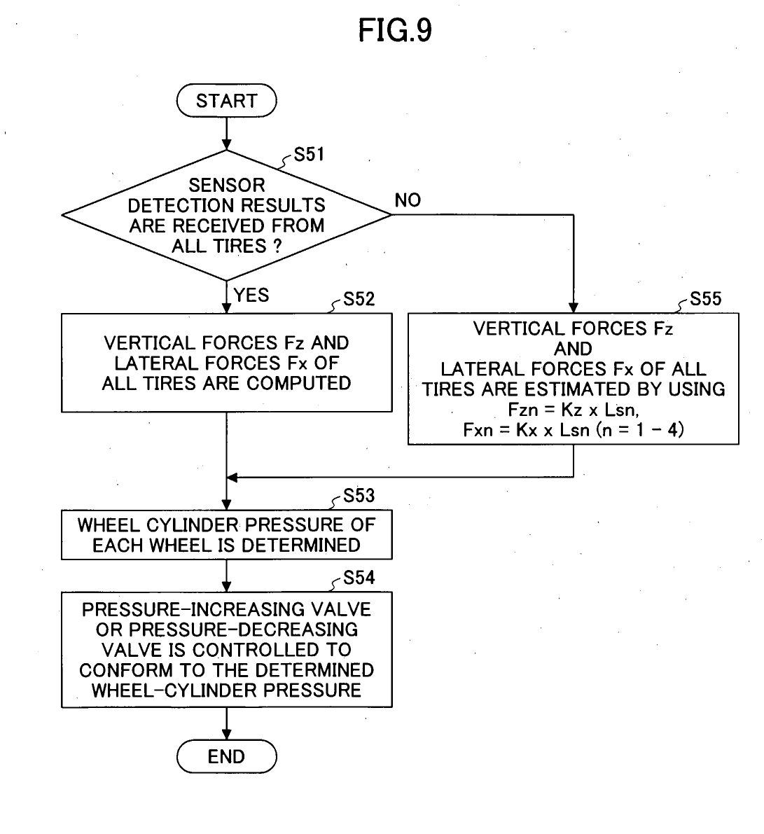

FIG. 9 is a flowchart for explaining the processing performed by the vehicle control device in the 3rd embodiment of the invention.

The composition of the vehicle control device in this embodiment is essentially the same as that of the 1st embodiment, and a description thereof will be omitted. The processing in the flowchart of FIG. 9 is started when the ignition key of the vehicle is turned ON by the user and power is supplied to the ECU 100, and thereafter, the processing is repeated at intervals of a predetermined time.

Since the processing of steps S51 to S54 in FIG. 9 is essentially the same as that of steps S11 to S14 in FIG. 6, a description thereof will be omitted. It is supposed that the formulas for computation of the vertical forces Fz1 to Fz4 and the lateral forces Fx1 to Fx4 are the same as those in the 1st embodiment.

The stroke quantity of the suspension provided to the wheel 14 which contains the tire 18 with the suspended use of the detection results of acceleration sensor 26 is set to Ls1. The stroke quantity of the suspension provided to the wheel 14 which contains the tire 18 on the front-and-rear same side and the right-and-left opposite side of the tire 18 with the suspended use of the detection results of acceleration sensor 26 is set to Ls2. The stroke quantity of the suspension provided to the wheel 14 which contains the tire 18 on the front-and-rear opposite side and the right-and-left same side of the tire 18 with the suspended use of the detection results of acceleration sensor 26 is set to Ls3. The stroke quantity of the suspension provided to the wheel 14 containing the tire 18 on the front-and-rear opposite side and the right-and-left opposite side is set to Ls4.

When a detection result from one tire 18 among the four tires 18 is not received, the exerted-force estimation unit 102 computes stroke quantity Ls of the suspension from the detection results of stroke sensor 114, and performs computation using the formulas: Fzn=Kz×Lsn and Fxn=Kx×Lsn (n=1 to 4), to estimate the vertical force Fz and the lateral force Fx acting on the grounding surface for all the tires 18 (S55).

Since there is correlation between the stroke quantity Ls and the vertical force Fz and lateral force Fx of the wheel 14, the vertical force Fz and lateral force Fx can be estimated by multiplying the stroke quantity Ls by the coefficient. The coefficient Kz and the coefficient Kx for performing such computation are stored beforehand in the memory device 104, and the exerted-force estimation unit 102 computes the vertical force Fz and the lateral force Fx of all the tires 18 by making reference to the stored coefficients Kz and Kx. The coefficient Kz and the coefficient Kx may be made into different values for every wheel 14.

The formula for estimating the force acting on tires 18, such as vertical force Fz, lateral force Fx, etc. may not be restricted to the above-mentioned formulas, and such computation may be performed accordance with other formulas using stroke quantity Ls. The mapping of the vertical force Fz and the lateral force Fx for all the tires 18 according to the stroke quantity Ls may be used.

The exerted-force estimation unit 102 may compute acceleration Az in the vertical direction of the vehicle body 12 from the detection results of the spring top G sensor 115, instead of stroke quantity Ls of stroke sensor 114, and may perform computation using the formulas: Fzn=Kz×Azn and Fxn=Kx×Azn (n=1 to 4). The vertical force Fz and the lateral force Fx which act on each grounding surface may be estimated for all the tires 18.

Similar to the above-described embodiment, the coefficient Kz and coefficient Kx are stored beforehand in the memory device 104. The computation of vertical force Fz and lateral force Fx of each tire 18 may not be restricted to the above-mentioned formulas, and such computation may be performed in accordance with other formulas using the acceleration Az. The mapping of the vertical force Fz and the lateral force Fx for all the tires 18 according to the acceleration Az may be used.

In this embodiment, the ECU 100 estimates the force acting on tire 18 or wheel 14, using effectively the body side detection unit, such as stroke sensor of the suspension, and the spring top G sensor, when a malfunction occurs in the communication path of acceleration sensor 26 or its detection result. The ECU 100 detects the force acting on each of tire 18, by either acceleration sensor 26 or the body side detection unit. For example, if that estimate the force acting on a certain tire 18, using the detection result of the body side detection unit, and acceleration sensor 26 detects the force acting on other tires 18 etc. uses the sensing device with which kinds differ. Since the objects for detection differ from the first, it may occur that the timing from which the force changes differs or the magnitude of the forces differs. According to this embodiment, a difference of such a detection result by using the sensing device with which kinds differ can be controlled.

In this embodiment, when not receiving a detection result from the plurality of tires 18 among the four tires 18, the exerted-force estimation unit 102 estimates the force acting on each of all the tires 18, by using the detection results of the body side detection units. The ECU 100 may be configured to suspend the attitude control which is performed using the force or acceleration acting on the wheel.

The exerted-force estimation unit 102 may estimate the force acting on the plurality of wheels 14, using the detection result of the body side detection unit, when use of the detection result of acceleration sensor 26 of one of wheels 14 is suspended.

For example, when the exerted-force estimation unit 102 suspends use of the detection result of acceleration sensor 26 of one wheel 14, the force acting on wheel 14 which suspended use of the detection result of acceleration sensor 26 of the wheel 14 and its adjacent wheel 14, and suspended use of the detection results may be estimated using the detection result of the body side detection unit.

The wheel 14 which uses the detection result of acceleration sensor 26 by this, and wheel 14 which estimates the force acting can be balanced. For this reason, in the vehicle control carried out using the force detected or estimated, it is possible to realize accurate stable control.

### 4th Embodiment

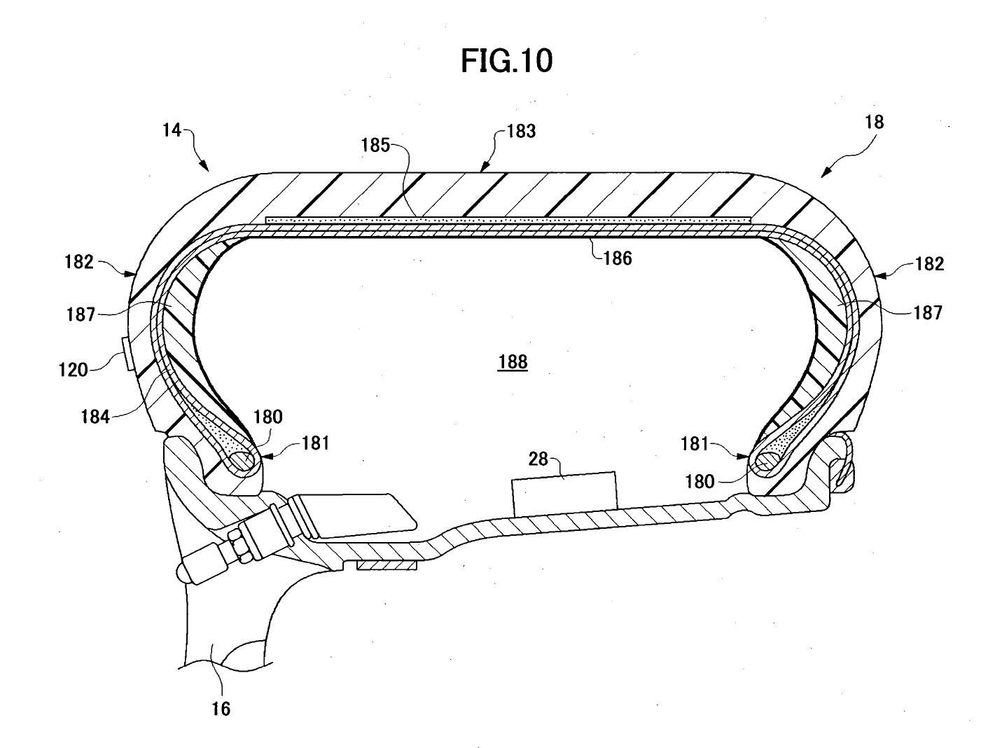

FIG. 10 is a partial cross-sectional view of the wheel 14 in the vehicle 10 in which the vehicle control device in the 4th embodiment of the invention is provided.

The composition of the vehicle control device in this embodiment is essentially the same as that of the above-mentioned embodiment, and the vehicle control device in this embodiment comprises the sensor units 120 instead of the acceleration sensors 26.

The sensor unit 120 is attached to the sidewall part 182 external surface of the tire 18. Rather than the middle height position of tire 18 section height, sensor unit 120 is shifted minutely and arranged at the core side of the tire 18.

The sensor unit 120 is provided as a mold object of the letter of a block which unified the magnetic sensor element which has an interval to a magnet and this magnet and faces them via the elastic member. A Hall device etc. may be adopted as a magnetic sensor element. In order to follow and carry out elastic deformation to a motion of sidewall part 182, the elastic member provided in sensor unit 120 is made of rubber etc.

It is attached with the sense toward which the gain which connects a magnet and a magnetic sensor element inclines Chuo Line used as the maximum at an angle of predetermined to the tire radial direction line, and sensor unit 120 can detect the shear strain ε γ of the surface distortion ε of the sidewall part 182. Thus, the detected shear strain ε γ indicates the linear correlation to each of lateral force Fx which acts on the grounding surface of tire 18, order force Fy, and vertical force Fz.

For this reason, it is possible by detecting shearing distortion a εγ to detect correctly the lateral force Fx, order force Fy, and vertical force Fz.

The plurality of sensor units 120 are disposed in the direction of a tire periphery to the external surface of sidewall part 182. In this embodiment, a total of eight sensor units 120 are arranged at intervals of 22.5 degrees in the tire peripheral direction on the external surface of the grounding surface part 182. The sensor unit 120 is connected to the transmitter 28 via the amplifier 27, respectively, and the battery 29 which supplies electric power to the acceleration sensors 26, the amplifiers 27 and the transmitter 28 is provided in each of the wheels 14. In this embodiment, one transmitter 28 is assigned to the four sensor units 120. (and the amplifiers 27).

When not receiving a detection result from one tire 18 among four tires 18, it is determined that a malfunction produced by the exerted-force computation unit 101 in either sensor unit 120 provided in tire 18 to which a receipt of letter is not carried out, amplifier 27 and transmitter 28.

The exerted-force computation unit 101 not only computes vertical force Fz2, Fz3 and Fz4, lateral force Fx2, Fx3, and Fx4 of tire 18 for the continued use of the detection result of sensor unit 120 like the above-mentioned embodiment, but the computation unit, the tire 18 order force Fy for the continued use of detection result of sensor unit 1202, Fy3, and Fy4 are computed using the detection result of received sensor unit 120.

The exerted-force estimation unit 102 not only estimates vertical force Fy1 and lateral force Fx1 as in the above-mentioned embodiment.

By using the formula Fy1=Fy2×Fy3/Fy4, the force Fy before and after acting on tire 18 which suspended use of detection result of sensor unit 1201 is estimated.

As for the ratio of force Fy before and after acting on each of wheel 14, the relation of the front left wheel:the front right wheel=the rear left wheel:the rear right wheel is usually materialized like vertical force Fz and lateral force Fx.

For this reason, even when use of the detection result of sensor unit 120 of one wheel 14 is suspended, it is possible to estimate force Fy before and after acting on wheel 14 which suspended use of the detection result of sensor unit 120 by the above-mentioned formula.

In this embodiment, all of lateral force Fx1 which acts on tire 18 which suspended use of the detection result of sensor unit 120, order force Fy1, and vertical force Fz1 can be estimated.

In this embodiment, the force acting on tire 18 which suspended use of the detection result of sensor unit 120 may be estimated like the 2nd embodiment using the detection result of the body side detection unit instead of using the detection result of received sensor unit 120. Of course, the force acting on plurality or all the wheels 14 may be estimated like the 3rd embodiment using the detection result of the body side detection unit.

As for this invention, what is not limited to an above-mentioned embodiment and combined each element of this embodiment suitably is effective as an embodiment of this invention. It is also possible to add modification of various kinds of design changes etc. to this embodiment based on a person's skilled in the art knowledge, and the embodiment to which such modification is added is also contained in the scope of this invention, and it deals in it.

Instead of acceleration sensor 26 of the above-mentioned embodiment, or sensor unit 120, the acceleration sensor which detects acceleration into wheel 14 or tire 18 may be arranged. The vehicle control device may control the position of vehicle 10 using the acceleration which acts on wheel 14 instead of the force acting on wheel 14 like the above-mentioned embodiment, such as controlling each braking force of wheel 14.

Also in the vehicle control device which controls the position of vehicle 10 by this using the acceleration which acts on wheel 14, it is possible to estimate the acceleration which acts on wheel 14 which suspended use of the detection result of an acceleration sensor.

Such an acceleration sensor may be formed with an inflation pressure sensing device etc., and may transmit the detection results of acceleration sensor for the vehicle body 12 using the transmitter which transmits the detection result by this inflation pressure sensing device to the vehicle body 12.

The exerted-force estimation unit 102 uses the detection result of acceleration sensor 26 of other one wheel 14, when use of the detection result of acceleration sensor 26 of one wheel 14 is suspended among four wheels 14. The force or acceleration which acts on wheel 14 which suspended use of the detection result of acceleration sensor 26 may be estimated. When the vehicle is running by fixed speed, even if a vehicle is circling a front wheel and a rear wheel, a stationary state, it is conceivable that the force or acceleration acts by the same ratio.

Similarly, when the vehicle is in a rectilinear-propagation condition, even if road speed is decreasing or increasing, the right-side wheels and the left-side wheels, a stationary state it is thought that the force or acceleration acts by the same ratio.

For this reason, it is possible to estimate the force or acceleration which acts on wheel 14 which suspended use of the detection result of acceleration sensor 26 using the detection result of acceleration sensor 26 of other one wheel 14.

In this case, exerted-force estimation unit 102 may estimate the force or acceleration which acts on wheel 14 which suspended use of the detection result using the detection result of acceleration sensor 26 of wheel 14 which suspended use of the detection result, and adjacent wheel 14.

The exerted-force estimation unit 102 uses the detection result of acceleration sensor 26 of other two wheels 14, when use of the detection result of acceleration sensor 26 of one wheel 14 is suspended among four wheels 14. The force or acceleration which acts on wheel 14 which suspended use of the detection result of acceleration sensor 26 may be estimated.

The force or acceleration which acts on wheel 14 in high accuracy by this compared with the case where the detection result of acceleration sensor 26 of other one wheel 14 is used can be estimated.

The exerted-force estimation unit 102 may be the case that the detection result of acceleration sensor 26 can be used not only in since the detection result of acceleration sensor 26 is not received, when it cannot use but a predetermined case, or may suspend use of the detection result of acceleration sensor 26 of one of the wheels 14.

Also in this case, exerted-force estimation unit 102 may estimate the force or acceleration which acts on wheel 14 which suspended use of the detection result of acceleration sensor 26 using the detection result of acceleration sensor 26 of other wheels 14.

For example, although the detection result of acceleration sensor 26 is receivable, it is conceivable that there are a case which should use the detection result of acceleration sensor 26 from a viewpoint of the detecting accuracy of acceleration sensor 26 where it does not come out, and a case which should use the detection results of acceleration sensors 26 since a malfunction is monitored at by the detection result of acceleration sensor 26 where it does not come out.

In this case, the ECU 100 determines whether a malfunction occurs in either acceleration sensor 26 by using the detection results of acceleration sensors 26.

In this case, the ECU 100 functions as an unusual detection unit of acceleration sensor 26. The ECU 100 determines whether a malfunction occurs in either acceleration sensor 26 by judging whether the detection result of acceleration sensor 26 has unusual vehicle 10 during a fixed-speed running or a stop. It is beforehand shown clearly by the experiment as a detection result when acceleration sensor 26 breaks down whether the detection result of acceleration sensor 26 is unusual, and the value of the predetermined detection result determined that acceleration sensor 26 is unusual should just be stored in the memory device 104.

Moreover, when the vehicle 10 compares the detection results of the acceleration sensors 26 between the respective wheels 14 during a fixed-speed running or a stop, it may be determined whether a malfunction occurs in either acceleration sensor 26. The circuit of acceleration sensor 26 inside may be constituted so that the output of a predetermined signal may be suspended, when acceleration sensor 26 outputs a predetermined signal when a malfunction arises.

The ECU 100 may determine whether a malfunction occurs in acceleration sensor 26 by judging whether this signal is inputted from acceleration sensor 26. When a malfunction occurs in either acceleration sensor 26, and the detection results cannot be acquired or the accuracy of the acquired detection result may not have sufficient accuracy, the ECU 100 can suspend use of the detection results of the acceleration sensors 26.

The exerted-force estimation unit 102 may determine whether according to predetermined conditions, use of the detection result of acceleration sensor 26 is suspended irrespective of whether a malfunction occurs in any acceleration sensor 26. In this case, exerted-force estimation unit 102 functions as an availability judgment part of acceleration sensor 26. For example, when the progress period after manufacture of acceleration sensor 26 installed in wheel 14 is more than a prescribed period, the case where the accuracy of the detection result of acceleration sensor 26 may fall can be considered.

The exerted-force estimation unit 102 may suspend use of the detection result of such an acceleration sensor 26 irrespective of whether a malfunction are in any acceleration sensor 26, when the progress period after manufacture of acceleration sensor 26 is more than a prescribed period.

The engine ECU may determine engine torque using the force or acceleration which acts on the force acting on the detected wheel or acceleration, and the estimated wheel. In the vehicle provided with the throttle motor as a throttle opening control unit which controls the throttle for controlling the suction amount to an engine, and opening of this throttle, using the force or acceleration which acts on the force acting on the detected wheel or acceleration, and the estimated wheel, by controlling actuation of a throttle motor, engine ECU may control opening of a throttle and may control engine torque.

In the vehicle which it has, the injection control unit which controls the amount of fuel supplies to the engine (or the engine ECU), using the force or acceleration which acts on the force acting on the detected wheel or acceleration, and the estimated wheel, by controlling an injection control unit, the amount of fuel supplies to an engine may be controlled, and engine torque may be controlled.

Thus, by controlling the engine torque, the driving force which drives wheel 14 is controllable. Therefore, the ECU 100 functions as a driving force determination unit to determine the driving force which drives a wheel, using the detected force, acceleration, the estimated force, or acceleration.

The engine ECU functions as a drive control unit which controls the driving force which drives wheel 14 so that determined driving force may be realized.

For example, suppose that the automotive vehicle is provided with an input shaft which is connected to the steering wheel, an output shaft which is connected through the steering gear to the steering shaft provided for steering the vehicle wheels by moving the steering shaft in the shaft direction, and a transfer ratio varying unit which varies the turning angle of the output shaft relative to the turning angle of the input shaft. A steering ECU may be provided in the vehicle to control the transfer ratio variable unit by using either the detected force or acceleration acting on the force acting on the detected wheel or acceleration, and the estimated wheel, and the turning angle of the output shaft over the turning angle of an input shaft may be changed.

In the vehicle in which the independent steering of each of the four wheels is possible, the steering ECU which controls the steering angle of each wheel is provided. It is the force or acceleration which acts on a wheel, and each steering angle of four flowers may be determined using the force or acceleration which acts on the force acting on the detected wheel or acceleration, and the estimated wheel.

In the vehicle which has a vehicle rotation rudder control device controlled to steer the four flowers independently by this using the force or acceleration acting on a wheel, also when the detection result by the detection unit of some wheels cannot be used, four flowers can be independently controlled by estimating this.

In the vehicle which each of four wheels is provided with the wheel drive motor as a wheel driving unit, and can drive each wheel independently, the ECU 100 the driving torque given to each of a wheel may be determined using the force or acceleration which acts on the force in each wheel of acting on the detected wheel or acceleration, and the estimated wheel.

The ECU 100 may control a wheel drive motor to drive each of a wheel by the determined driving torque. Therefore, the ECU 100 functions as a driving force determination unit to determine the driving force which drives a wheel, using the detected force, acceleration, the estimated force, or acceleration.

The engine ECU functions as a drive control unit which controls the driving force which drives wheel 14 so that determined driving force may be realized.

The present invention is not limited to the above-described embodiments, and variations and modifications may be made without departing from the scope of the present invention.

Further, the present application is based upon and claims the benefit of priority of Japanese patent application No. 2005-344722, filed on Nov. 29, 2005, the entire contents of which are incorporated herein by reference.

1. A wheel-state estimation device which estimates a force or acceleration acting on a wheel provided in an automotive vehicle, comprising:
a plurality of wheel side detection units respectively provided in a plurality of wheels of the vehicle, each wheel side detecting unit detecting a force or acceleration acting on a corresponding one of the wheels; and
an estimation unit estimating, when use of detection results of one of the wheels from one of the plurality of wheel side detection units is suspended, a force or acceleration acting on said one of the wheels with respect to the suspended use of the detection results, by using detection results of other wheels from other wheel side detection units.

2. The wheel-state estimation device according to claim 1, wherein the plurality of wheel side detection units are respectively provided in four wheels of the vehicle, and the estimation unit is configured to estimate, when use of detection results of one of the four wheels from one of the plurality of wheel side detection units is suspended, a force or acceleration acting on said one of the four wheels with respect to the suspended use of the detection results, by using detection results of other wheels from other wheel side detection units.

3. The wheel-state estimation device according to claim 2, wherein, when S1 denotes a force or acceleration acting on said one of the four wheels with respect to the suspended use of the detection results, S2 and S3 respectively denote forces or accelerations acting on wheels of the four wheels which are located adjacent to said one of the four wheels, and S4 denotes a force or acceleration acting on a wheel of the four wheels which is located diagonally opposite to said one of the four wheels, the estimation unit is configured to estimate the force or acceleration S1 by using the formula S1=(S2×S3)/S4.

4. A vehicle control device which is adapted to control an automotive vehicle, comprising:
a plurality of wheel side detection units respectively provided in a plurality of wheels of the vehicle, each wheel side detecting unit detecting a force or acceleration acting on a corresponding one of the wheels;
an estimation unit estimating, when use of detection results of one of the wheels from one of the plurality of wheel side detection units is suspended, a force or acceleration acting on said one of the wheels with respect to the suspended use of the detection results, by using detection results of other wheels from other wheel side detection units;
a braking force determination unit determining a target braking force to be exerted on each wheel, by using the detected force or acceleration and the estimated force or acceleration; and
a braking control unit controlling a braking force on each wheel so as to conform to the determined target braking force.

5. A vehicle control device which is adapted to control an automotive vehicle, comprising:
a plurality of wheel side detection units respectively provided in a plurality of wheels of the vehicle, each wheel side detecting unit detecting a force or acceleration acting on a corresponding one of the wheels;
an estimation unit estimating, when use of detection results of one of the wheels from one of the plurality of wheel side detection units is suspended, a force or acceleration acting on said one of the wheels with respect to the suspended use of the detection results, by using detection results of other wheels from other wheel side detection units;
a driving force determination unit determining a target driving force to drive each wheel, by using the detected force or acceleration and the estimated force or acceleration; and
a drive control unit controlling a driving force which drives each wheel so as to conform to the determined target driving force.

6. (canceled)

7. (canceled)

8. (canceled)

9. (canceled)

10. (canceled)

11. (canceled)

12. (canceled)

13. (canceled)
